(19) United States
(12) Patent Application Publication
(10) Pub. No.: US 2026/0222290 A1
(43) Pub. Date: Jul. 30, 2026

(54) DEVICE AND METHOD FOR PROVIDING NOTIFICATION MANAGEMENT SERVICE IN WIRELESS COMMUNICATION SYSTEM

(71) Applicant: SAMSUNG ELECTRONICS CO., LTD., Suwon-si, Gyeonggi-do (KR)

(72) Inventors: Cheolung LEE, Suwon-si (KR); Hyesung KIM, Suwon-si (KR)

(21) Appl. No.: 19/145,463

(22) PCT Filed: Dec. 28, 2023
(86) PCT No.: PCT/KR2023/021821

§ 371 Date: Jul. 2, 2025

(30) Foreign Application Priority Data
Jan. 4, 2023 (KR) 10-2023-0001458

(51) Int. Cl. H04L 41/0813; H04L 41/0686; H04W 60/04; H04W 64/00

(52) U.S. Cl. CPC H04L 41/0813; H04L 41/0686; H04W 60/04; H04W 64/00

(57) ABSTRACT

The present disclosure relates to a 5G or 6G communication system for supporting higher data transmission rates. According to one embodiment of the present disclosure, a method for an edge configuration server (ECS) in a wireless communication system is provided, and comprises the operations of: receiving, from an edge enabler server (EES), a first message including available notification management server (NMS) information; receiving, from an edge enabler client (EEC), a second message including notification management client (NMC) information configured in a user equipment; configuring, on the basis of the NMS information and NMC information, NMS information available on the user equipment; and transmitting, to the EEC, a third message including the configured NMS information.

### TECHNICAL FIELD

The disclosure relates generally to wireless communication systems and, more specifically, to devices and methods for providing notification management services in wireless communication systems.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mm Wave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DETAILED DESCRIPTION OF THE INVENTION

### Technical Problem

Based on the above discussion, the disclosure provides a device and method for providing a notification management service in a wireless communication system.

### Technical Solution

According to various embodiments of the disclosure, there is provided a method of an edge enabler client (EEC) in a wireless communication system. The method comprises transmitting, to an edge enabler server (EES), notification management client (NMC) information supported by a UE, including preferred channel information of the UE for a notification subscription service, identifying the NMC information received from the EEC and searching for a notification management server (NMS) supporting a UE preferred channel available in the EES, selecting an NMS suitable for an area capable of providing a notification subscription service to the UE, transmitting information about an NMS accessible by the EES to the EEC, transmitting, to the ECS by the EEC, NMC information supported by the UE, including preferred channel information about the UE for a notification subscription service, identifying the NMC information received from the EEC, and searching for an NMS supporting a UE preferred channel available in the ECS, selecting an NMS suitable for an area capable of providing a notification subscription service to the UE, transmitting, to the EEC, information about an NMS accessible by the ECS, including and transmitting the information about the NMS accessible by the ECS in a registration request message, to the ECS, and including the NMS information received from the EES by the ECS in a response message to the registration request message and transmit NMS information supportable by the EES or the ECS to the UE.

According to an embodiment of the disclosure, there is provided a method of an edge configuration server (ECS) in a wireless communication system. The method comprises receiving, from an edge enabler server (EES), a first message including available notification management server (NMS) information, receiving, from an edge enabler client (EEC), a second message including notification management client (NMC) information configured in a user equipment (UE), configuring NMS information available in the UE based on the NMS information and the NMC information, and transmitting, to the EEC, a third message including the configured NMS information.

According to an embodiment of the disclosure, there is provided an edge configuration server (ECS) in a wireless communication system. The ECS comprises a transceiver, and at least one processor coupled to the transceiver. The at least one processor is configured to receive, from an edge enabler server (EES) through the transceiver, a first message including available notification management server (NMS) information, receive, from an edge enabler client (EEC) through the transceiver, a second message including notification management client (NMC) information configured in a user equipment (UE), configure NMS information available in the UE based on the NMS information and the NMC information, and transmit, to the EEC through the transceiver, a third message including the configured NMS information.

Other technical features will be readily apparent to one of ordinary skill in the art from the drawings, descriptions and claims below.

Before describing the invention in detail below, it may be preferable to set forth definitions of certain words and phrases used throughout the disclosure. The term “couple” and its derivatives denote any direct or indirect communication between two or more elements, whether those elements are in physical contact with each other. The terms “transmit,” “receive,” and “communicate,” and their derivatives, encompass both direct and indirect communication. The terms “include” and “comprise” and their derivatives imply inclusion without limitation. The term “or” is an inclusive term meaning “and/or.” The phrase “associated with” and its derivatives mean, e.g., “include,” “be included within,” “interconnect with,” “contain,” “be contained within,” “connect to or with,” “couple to or with,” “be communicable with,” “cooperate with,” “interleave,” “juxtapose,” “be proximate to,” “be bound to or with,” “have,” “have a property of,” “have a relationship to or with.” The term “controller” means any device, system, or part thereof that controls at least one operation. The controller may be implemented in hardware or a combination of hardware and software and/or firmware. Functions associated with any particular controller may be centralized or distributed, either locally or remotely. The phrase “at least one of”, when used with a list of items, means that different combinations of one or more of the listed items may be used, implying that only one item in the list is required. For example, “at least one of A, B, and C” includes any of the following combinations: A, B, C, A and B, A and C, B and C, and A and B and C.

Further, the various functions described below may be implemented or supported by one or more computer programs, each of which is composed of computer-readable program code and implemented on a computer-readable medium. The terms “application” and “program” refer to one or more computer programs, software components, sets of instructions, procedures, functions, objects, classes, instances, related data, or portions thereof suitable for implementation in suitable computer-readable program code. The phrase “computer-readable program code” includes any type of computer code, including source code, object code, and executable code. The phrase “computer-readable medium” includes any type of medium that may be accessed by a computer, such as read only memory (ROM), random access memory (RAM), a hard disk drive, a compact disc (CD), a digital video disc (DVD), or any other type of memory. A “non-transitory” computer-readable medium excludes wired, wireless, optical, or other communication links that transmit transitory electrical or other signals. A non-transitory computer-readable medium include media on which data may be permanently stored, and media on which data may be stored and later overwritten, such as rewritable optical discs or erasable memory devices.

Definitions for other specific words and phrases are provided throughout the disclosure. Those skilled in the art will recognize that in many, if not most, cases, such definitions apply to prior as well as subsequent uses of the words and phrases so defined.

### Advantageous Effects

The device and method according to various embodiments of the disclosure may provide a device and method for providing an edge computing service in a wireless communication system.

Effects obtainable from the disclosure are not limited to the above-mentioned effects, and other effects not mentioned may be apparent to one of ordinary skill in the art from the following description.

### BRIEF DESCRIPTION OF DRAWINGS

FIG. 1 is a view illustrating a hierarchical structure of an edge computing application in a wireless communication system according to an embodiment of the disclosure;

FIG. 2 is a view illustrating interworking between a 3rd generation partnership project (3GPP) network and an edge computing server in a wireless communication system according to an embodiment of the disclosure;

FIG. 3 is a view schematically illustrating a procedure for creating a notification channel related to a notification management service in a wireless communication system according to an embodiment of the disclosure;

FIG. 4 is a view schematically illustrating a procedure for creating a notification channel related to a notification management service in a wireless communication system according to an embodiment of the disclosure;

FIG. 5 is a view illustrating an internal structure of a network entity in a wireless communication system according to an embodiment; and

FIG. 6 is a view illustrating an internal structure of a UE in a wireless communication system according to an embodiment.

### MODE FOR CARRYING OUT THE INVENTION

The terms as used herein are provided merely to describe some embodiments thereof, but not to limit the scope of other embodiments of the present disclosure. It is to be understood that the singular forms “a,” “an,” and “the” include plural references unless the context clearly dictates otherwise. The terms including technical and scientific terms used herein have the same meaning as commonly understood by one of ordinary skill in the art to which the embodiments of the present disclosure belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein. In some cases, the terms defined herein may be interpreted to exclude embodiments of the present disclosure.

Methods described below in connection with embodiments are based on hardware. However, embodiments of the disclosure encompass technology using both hardware and software and thus do not exclude software-based methods.

As used herein, terms denoting signals, terms denoting channels, terms denoting control information, terms denoting network entities, terms denoting data stored in network entities, terms denoting messages transmitted/received between entities, and terms denoting device components are provided as an example for ease of description. The disclosure is not limited to the terms, and other terms equivalent in technical concept may also be used.

Further, although the disclosure describes various embodiments using terms used in some communication standards (e.g., 3rd generation partnership project (3GPP)), this is merely an example for description. Various embodiments of the disclosure may be easily modified and applied in other communication systems.

In order to meet the demand for wireless data traffic soaring since the 4G communication system came to the market, there are ongoing efforts to develop enhanced 5G communication systems or pre-5G communication systems. For the reasons, the 5G communication system or pre-5G communication system is called the beyond 4G network communication system or post long term evolution (LTE) system.

For higher data transmit rates, 5G communication systems are considered to be implemented on ultra-high frequency bands (mmWave), such as, e.g., 60 GHz. To mitigate pathloss on the ultra-high frequency band and increase the reach of radio waves, the following techniques are taken into account for the 5G communication system: beamforming, massive multi-input multi-output (MIMO), full dimensional MIMO (FD-MIMO), array antenna, analog beamforming, and large scale antenna.

Also being developed are various technologies for the 5G communication system to have an enhanced network, such as evolved or advanced small cell, cloud radio access network (cloud RAN), ultra-dense network, device-to-device (D2D) communication, wireless backhaul, moving network, cooperative communication, coordinated multi-point (CoMP), and interference cancellation.

There are also other various schemes under development for the 5G system including, e.g., hybrid FSK and QAM modulation (FQAM) and sliding window superposition coding (SWSC), which are advanced coding modulation (ACM) schemes, and filter bank multi-carrier (FBMC), non-orthogonal multiple access (NOMA) and sparse code multiple access (SCMA), which are advanced access schemes.

Meanwhile, the 3GPP, which is in charge of cellular mobile communication standardization, has named the new core network structure 5G core (5GC) and standardized the same to promote the evolution from the legacy 4G LTE system to the 5G system.

5GC supports the following differentiated functions as compared to the evolved packet core (EPC), which is the legacy network core for 4G.

First, 5GC adopts the network slicing function. 5GC is required to support various types of user equipment (UE) and services. For example, such services may include enhanced mobile broadband (eMBB), ultra-reliable low latency communications (URLLC), and massive machine-type communications (mMTC). These UEs/services have different requirements for the core network. For example, the eMBB service requires a high data rate while the URLLC service requires high stability and low latency. Network slicing is technology proposed to meet such various requirements.

Network slicing is a method for creating multiple logical networks by virtualizing one physical network, and the network slice instances (NSIs) may have different characteristics. Therefore, various service requirements may be met by allowing each NSI to have a network function (NF) suited for its characteristics. Various 5G services may be efficiently supported by allocating an NSI meeting required service characteristics for each UE.

Second, 5GC may seamlessly support the network virtualization paradigm by separating the mobility management function and the session management function. In legacy 4G LTE, all UEs may receive services over the network through signaling exchange with a single core device called the mobility management entity (MME) in charge of registration, authentication, mobility management and session management functions. However, in 5G, the number of UEs explosively increases and mobility and traffic/session characteristics that need to be supported according to the type of UE are subdivided. Resultantly, if all functions are supported by a single device, such as MME, the scalability of adding entities for each required function may decrease. Accordingly, various functions are under development based on a structure that separates the mobility management function and the session management function to enhance the scalability in terms of function/implementation complexity of the core equipment in charge of the control plane and the signaling load.

Meanwhile, edge computing systems are recently emerging. In the edge computing system, a user equipment (UE) may establish a data connection to an edge data network (EDN), located nearby to use a low-latency or broadband service, to receive an edge computing service. The edge computing service may be provided through an edge application server (EAS) driven in an edge computing platform or an edge hosting environment operated by an edge enabler server (EES) of a specific edge data network. In other words, the UE may receive an edge computing service from the edge application server (EAS) located closest to the area where the UE is located.

The disclosure provides a method and device for searching for and obtaining an edge application server capable of using a function of an application federated with an edge application server when a UE moves.

The disclosure also provides an operation and device for indicating whether information for federated edge computing service-related servers previously connected when an edge application server providing a federated function is re-executed is valid and whether it is reusable.

The disclosure also provides a method for searching for a valid edge application server when failing to discover an edge application server for providing a federated function.

The disclosure also provides a federated context processing method for providing an edge application server with federated edge application server information (edge application server profile, e.g., edge application server address/service area/status/service KPI et al.) and an element (e.g., federated EAS indicator, available APIs) capable of identifying a service of an available federated application server and an edge application server providing a federated function by an application enabler server.

The disclosure also provides a method for minimizing UE signaling for re-obtaining edge application information and UE's edge computing configuration information when an update for the information occurs.

According to an embodiment of the disclosure, a method performed by an edge enabler server (EES) in a wireless communication system supporting edge computing includes a process in which the EES receives a registration request message including a federated edge application server identifier from an edge application server (EAS), a process of providing federated EAS information valid for the EAS to the EAS, a process in which the EES selects a method for providing the EAS with EAS information capable of using the federated EAS, and a process of performing an operation based on the selected method for providing the federated EAS information.

Further, according to an embodiment of the disclosure, an edge enabler server (EES) in a wireless communication system supporting edge computing includes a transceiver and a processor configured to receive, through the transceiver, a registration request message including a context of a federated edge application server not configured in the EES, select a method for providing federated EAS information for the EAS, and perform an operation based on the selected providing method to provide the EAS information to the UE.

The present invention proposes a context relocation method for continuously providing a federated service of an edge application server when a UE moves. Proposed is a method for searching for an edge application server providing a federated function. Proposed is a method for requesting another edge data network to search when there is no edge application server providing a valid federated function in the same edge data network. Proposed is a method for an edge computing service entity to identify an edge application server providing a federated function. Proposed is a method for storing and providing a valid federated edge application server list. The corresponding context may occur according to the locational distributed deployment characteristics of edge computing services and the mobility of the UE.

The terms described below are ones defined considering functions in the disclosure. Since the terms may be varied according to the user's or operator's intent or custom, their definitions should be determined according to the contents throughout the disclosure.

The terms referring to network entities and entities of an edge computing system as used herein, the terms referring to messages, and the term referring to identification information are provided as an example for ease of description. Thus, the disclosure is not limited to the terms, and the terms may be replaced with other terms denoting objects with equivalent technical meanings.

Although terms and names as defined in the 3GPP system standard are used herein for ease of description, embodiments of the disclosure are not limited thereto or thereby, and the same may apply likewise to systems conforming to other standards.

The term ‘UE’ or ‘device’ as used in the disclosure may refer to a mobile station (MS), user equipment (UE), user terminal (UT), wireless terminal, access terminal (AT), terminal, subscriber unit (SU), subscriber station (SS), wireless device, wireless communication device, wireless transmit/receive unit (WTRU), mobile node, mobile, or may be denoted by other terms. Various examples of the terminal may include cellular phones, smart phones with wireless communication capabilities, personal digital assistants (PDAs) with wireless communication capabilities, wireless modems, portable computers with wireless communication capabilities, capturing/recording/shooting/filming devices, such as digital cameras, having wireless communication capabilities, game players with wireless communications capabilities, music storage and playback home appliances with wireless communications capabilities, Internet home appliances capable of wireless Internet access and browsing, or portable units or terminals incorporating combinations of those capabilities. Further, the terminal may include a machine to machine (M2M) terminal and a machine-type communication (MTC) terminal/device, but is not limited thereto. In the disclosure, the terminal may be referred to as an electronic device or simply as a device.

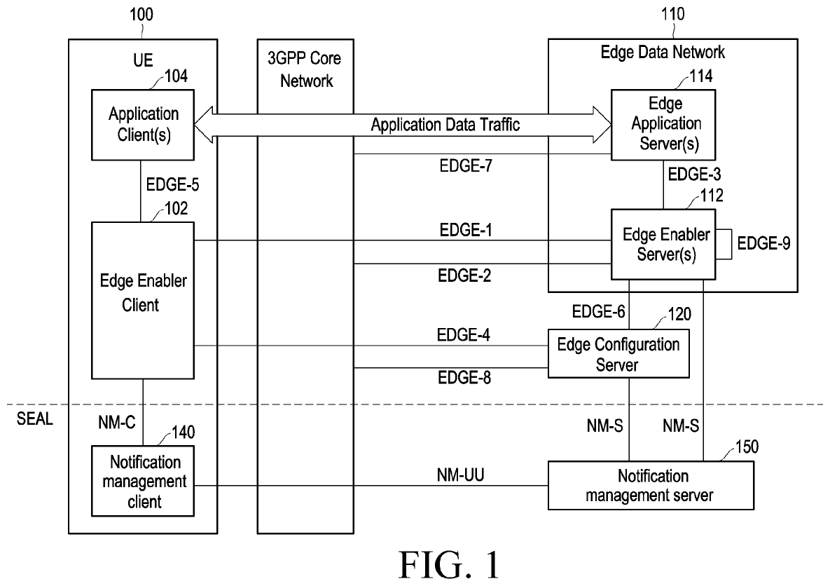

FIG. 1 is a view illustrating a hierarchical structure of an edge computing application in a wireless communication system according to an embodiment of the disclosure.

Referring to FIG. 1, an edge computing system may include at least one of an edge enabler server (EES) 112, an edge configuration server (ECS) 120, and an edge enabler client (EEC) 102.

In an embodiment, the EES 112 may build an edge hosting environment or edge computing platform and may have information about an edge application server (EAS) 114 running in the edge hosting environment.

The EES 112 may negotiate with the UE 100 to perform the function of connecting application client (AC) (s) 104 of the UE 100 and the EAS 114 in the edge hosting environment. The UE 100 supporting an edge computing system may have the EEC 102 built therein. The layer where interworking with the EEC 102 and the EAS 114 is performed may be referred to as an edge enabling layer. In the disclosure, the UE 100 having the EEC 102 built therein to configure an edge enabling layer may be various electronic devices, such as not only a smartphone but also an Internet of things (IoT) device and a vehicle.

The ECS 120 may know deployment information about the EES 112 and perform a function of transmitting configuration information for using the edge computing service to the UE 100. The configuration information may include at least one of edge data network connection information (e.g., data network name (DNN), single network slice selection assistance information (S-NSSAI), etc.), EDN service area (e.g., cell list, list of tracking areas (TAs), public land mobile network (PLMN) ID), or EES connection information (e.g., uniform resource identifier (URI)).

The EDN service area may be an EES available area configured by the EES 112. Based on the EDN service area, the UE 100 may obtain EES information accessible at a specific location. If the ECS 120 may know about the EAS running in the edge hosting environment of a particular EES, the UE 100 may also obtain the information (information about the EAS running in the edge hosting environment of the EES) through the EEC 102. The layer where the EEC and the ECS interwork may also be included in the edge enabling layer.

The EAS 114 is a third-party application server running in the edge computing system. Since the EAS runs on the infrastructure provided by the edge hosting environment, it may provide an ultra-low latency service at a location close to the UE 100.

The UE 100 may include at least one of an AC 104, an EEC 102 for linking the AC 104 with the edge computing service, or a mobile terminal (MT) for accessing the wireless communication system. The application of the UE 100 may mean a client application program provided by a third party and running in the UE 100 for a specific application service. A plurality of applications may run on the UE 100. At least one of the plurality of applications may use multi-access edge computing (MEC) services.

The EEC 102 in the UE 100 may refer to a client that performs operations in the UE 100 necessary for utilizing edge computing services. The EEC 102 in the UE 100 may determine what application is able to use the edge computing service and perform the operation of connecting the network interface to allow the data of the AC 104 in the UE 100 to be transferred to the EAS 114 providing the edge computing service.

In an embodiment, the operation for establishing a data connection for using the edge computing service in the UE 100 may be performed, through the MT, in the 3GPP communication layer. The 3GPP communication layer may mean a layer that performs modem operations for using a wireless communication system, and may establish a wireless connection for data communication, register the UE 100 with the wireless communication system, establish a connection for data transmission/reception to the wireless communication system, and transmit/receive data.

In an embodiment, the edge data network (EDN) 110 may be a local data network. The EAS(s) 114 and the EES 112 may be included in the EDN 110. The ECS 120 may provide components related to the EES 112. In an embodiment, the components related to the EES 112 may include details of the EDN 110 hosting the EES 112.

In an embodiment, the UE 100 may include a AC(s) 104 and an EEC 102. The EAS(s) 114, the EES 112, and the ECS 120 may interoperate with 3GPP core networks. When the service enabler layer architecture (SELA) notification management service is used, the EES 112 and the ECS 120 may interwork with the SEAL notification management server (or notification management server) 150, and the SEAL EEC may interwork with the SEAL notification management client (or notification management client) 140.

In FIG. 1, EDGE-1 to EGGE-8 represent network interfaces (e.g., reference points) between entities, and EDGE-1 to EGGE-8 may be represented as in Table 1 below, and the description of EDGE-1 to EGGE-8 may not be limited to the description in Table 1 below.

TABLE 1

| Reference | |
|---|---|
| Points | Description |
| EDGE-1 | EDGE-1 reference point enables interactions between the |
| | Edge Enabler Server and the Edge Enabler Client. It |
| | supports: a) registration and de-registration of the Edge |
| | Enabler Client to the Edge Enabler server; |
| | b) retrieval and provisioning of Edge Application Server |
| | configuration information; and |
| | c) discovery of Edge Application Servers available in the |
| | Edge Data Network. |
| EDGE-2 | Edge-2 reference point enables interactions between the |
| | Edge Enabler Server and the 3GPP Core Network. It |
| | supports access to 3GPP Core Network functions and APIs |
| | for retrieval of network capability information |
| EDGE-3 | EDGE-3 reference point enables interactions between the |
| | Edge Enabler Server and the Edge Application Servers. It |
| | support: a) registration of Edge Application Servers with |
| | availability information (e.g. time constraints, location |
| | constraints); |
| | b) de-registration of Edge Application Servers from the |
| | Edge Enabler Server; and |
| | c) providing access to network capability information |
| | (e.g. location information). |
| EDGE-4 | EDGE-4 reference point enables interactions between the |
| | Edge Configuration Server and the Edge Enabler Client. It |
| | supports provisioning of Edge configuration information |
| | to the Edge Enabler Client. |
| EDGE-5 | EDGE-5 reference point enables interactions between |
| | Application Client(s) and the Edge Enabler Client. |
| EDGE-6 | EDGE-6 reference point enables interactions between the |
| | Edge Configuration Server and the Edge Enabler Server. It |
| | supports registration of Edge Enabler Server information |
| | to the Edge Enabler Network Configuration Server. |
| EDGE-7 | EDGE-7 reference point enables interactions between the |
| | Edge Application Server and the 3GPP Core Network. It |
| | supports access to 3GPP Core Network functions and APIs |
| | for retrieval of network capability information. |
| EDGE-8 | EDGE-8 reference point enables interactions between the |
| | Edge Configuration Server and the 3GPP Core network. |
| EDGE-9 | EDGE-9 reference point enables interactions between two |
| | EESs. EDGE-9 reference point may be provided between |
| | EES within different EDN and within the same EDN. |

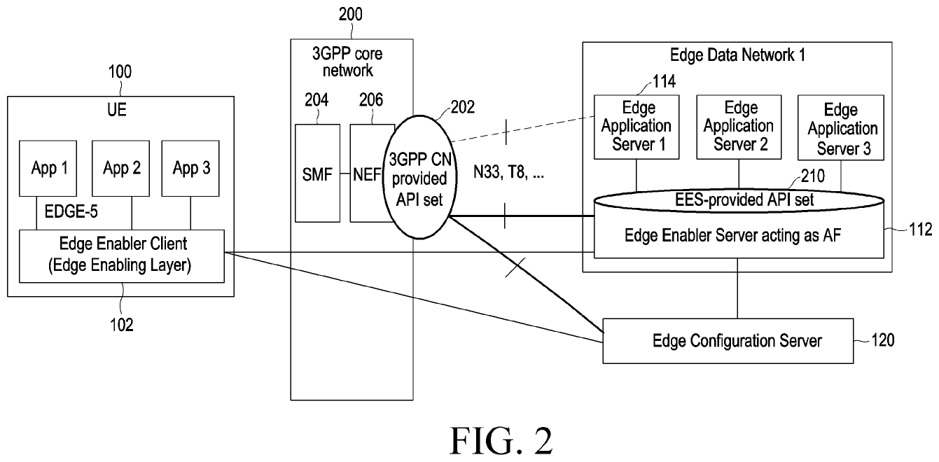

FIG. 2 is a view illustrating interworking between a 3GPP network and an edge computing server in a wireless communication system according to an embodiment of the disclosure.

Referring to FIG. 2, a 3GPP network 200 may provide an application programming interface (API) set 202 that may be utilized by an application function (AF). The EES 112 or the EAS 114 capable of performing the AF function may interwork with the 3GPP network 200 through the API set 202 provided by the 3GPP network 200. For example, a session management function (SMF) 204 that performs protocol data unit (PDU) session management may provide a session-related service API to an AF outside the core network 200 through a network exposure function (NEF) 206.

If there is no service level agreement between the EAS provider and the 3GPP network operator, the EAS may indirectly interwork with the 3GPP network 200 through the API set 210 provided by the EES to which it is registered.

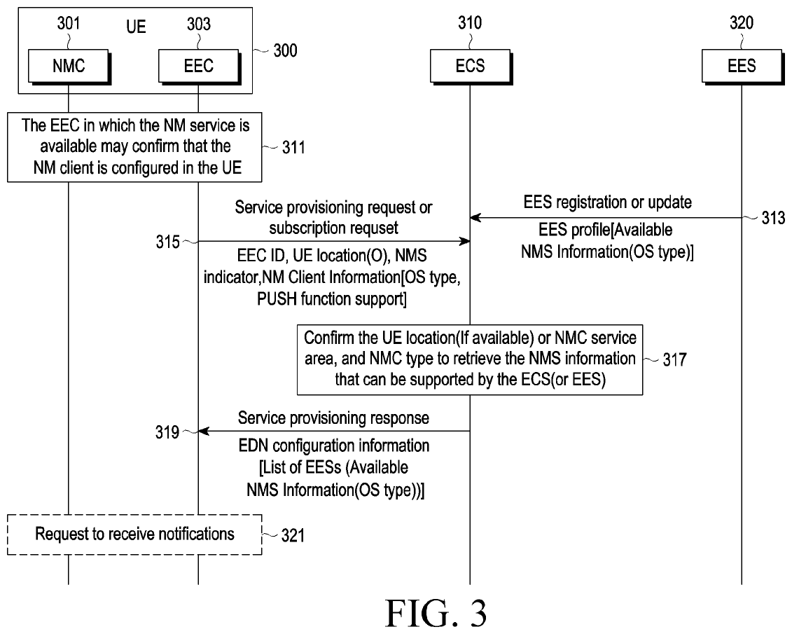

Even when the EAS provider has a service level agreement with a 3GPP network operator and may directly use the API set 202 provided by the 3GPP network 200, it may indirectly interwork with the 3GPP network 200 through the API set 210 provided by the EES 112 for efficient API use. FIG. 3 is a view schematically illustrating a procedure for creating a notification channel related to a notification management service in a wireless communication system according to an embodiment of the disclosure. The procedure for creating a notification channel related to the notification management service illustrated in FIG. 3 may include a procedure in which the ECS 310 sets notification management server information available in the ECS 310 and the EES 320 based on the notification management client (NMC) information about the UE 300 and transmits the set notification management server information to the UE 300.

In an embodiment, the UE 300 may include aT NMC 310 and an EEC 303. The EEC 303 may provide NMC information set in the UE 300 to the ECS 310. In an embodiment, the NMC information may be included in a service provisioning request message or a service provisioning subscription request message, and thus the EEC 303 may provide the NMC information set in the UE 300 to the ECS 310 through the service provisioning request message or the service provisioning subscription request message.

In an embodiment, the EES 320 may provide available notification management server (NMS) information to the ECS 310. The NMS information may be included in an EES registration request message or an EES registration update request message. Therefore, the EES 320 may provide available NMS information to the ECS 310 through EES registration request message or EES registration update request message.

In an embodiment, the ECS 310 may obtain supportable NMS information for the UE 300 based on the NMC information included in the service provisioning request message and the NMS information available in the ECS 310 or the EES 320. The ECS 310 may provide NMS information supportable for the UE 300 to the EEC 303. In an embodiment, the ECS 310 may include NMS information supportable for the UE 300 in a service provisioning response message, which is a response message to a service provisioning request message, and transmit a service provisioning response message including NMS information supportable for the UE 300 to the EEC 303.

The EEC 303 may identify notification management services available in the EEC 303 by utilizing NMC information (e.g., OS type, PUSH function support) configured for the UE 300 in advance.

In an embodiment, when the NMS information available to the EES 320 is configured in the EES 320 or the EES 320 may search for the NMS information available to the EES 320, the EES 320 may provide NMS information (e.g., OS type) available to the EES 320 to the ECS 310. For example, the EES 320 may provide the ECS 310 with the NMS information (e.g., OS type) available to the EES 320 by including the NMS information (e.g., OS type) available to the EES 320 in the registration request message or registration update request message and transmitting the registration request message or registration update request message including the NMS information (e.g., OS type) available to the EES 320 in the message to the ECS 310.

In an embodiment, the ECS 310 may store the NMS information available to the EES 320 received from the EES 320.

As described above, the procedure in which the ECS 310 configures the NMS information available in the ECS 310 and the EES 320 based on the NMC information about the UE 300 and transmits the configured MNS information to the UE 300 may be described in detail as follows.

In operation 311, a notification management service (NM service) may be available in the EEC 303, and the EEC 303 where the notification management service is useful may identify that the NM client (NMC) 301 is configured in the UE 300. Operation 311 is represented in FIG. 3 as “The EEC in which the NM service is available may confirm that the NM client is configured in the UE”.

In operation 313, the EES 320 may provide available NMS information to the ECS 310. The NMS information may be included in the EES registration request message or the EES registration update request message, and thus the EES 320 may provide available NMS information to the ECS 310 through the EES registration request message or the EES registration update request message. In an embodiment, the available NMS information may be included in an EES profile, and the available NMS information may include an OS type.

In operation 315, the EEC 303 may provide at least one of an EEC identifier (ID), NMC information (e.g., OS type, PUSH function support), position information for the UE 300, and an NMS indicator indicating that the EEC 303 provides a notification management service to the ECS 310. The EEC 303 may provide at least one of an EEC ID, NMC information (OS type, PUSH function support) configured in the UE 300, location information about the UE 300, and an NMS indicator indicating that the EEC 303 provides a notification management service to the ECS 310 through a service provisioning request message or a service provisioning subscription request message.

In operation 317, when the NMS indicator is included in the service provisioning request message or the service provisioning subscription request message received from the EEC 303, the ECS 310 may search for NMC information (e.g., OS type, PUSH function support) included in the service provisioning request message or the service provisioning subscription request message and the NMC information configured or stored in the ECS 310, available to the ECS 310 or the EES 320. The ECS 310 may consider service area information supported by the NMS and location information about the UE 300 or prediction path information for the UE 300 in order to search for available NMS information. The location information about the UE 300 may be a service provisioning request message or a service provisioning subscription request message received from the EEC 303, or, if necessary, location information about the UE 300 obtained by the EES 320 using the 5GC core network function. In operation 317, it is represented in FIG. 3 as “Confirm the UE location (If available) or NMC service area, and NMC type to retrieve the NMS information that can be supported by the ECS (or EES)”.

In operation 319, the ECS 310 may provide the EEC 303 with matching NMS information (e.g., NMS information available in the UE 300) based on the NMC information included in the service provisioning request message or the service provisioning subscription request message, and the searched ECS 310 or the NMS information available to the EES 320. In an embodiment, the ECS 310 may include NMS information supportable for the UE 300 in the service provisioning response message, which is a response message to the service provisioning request message, and transmit the service provisioning response message including NMS information supportable for the UE 300 to the EEC 303 to provide matching NMS information to the EEC 303. The service provisioning response message may include EDN configuration information, and the EDN configuration information may include matching NMS information. When the service provisioning response message includes NMS information supported by the EES 320, NMS information available to the EES 320 may be included in a sub item of a list of EESs included in the EDN configuration information.

In operation 319, the EEC 303 may receive a service provisioning response message, which is a response message to the service provisioning request message or the service provisioning subscription request message, from the ECS 310.

In operation 321, EEC 303 may identify the NMS information included in the received service provisioning response message and transfer a request message (e.g., a notification reception request message) for generating a notification channel based on the identified NMS information to the NMC 301 in order to receive a server notification through the notification channel from the ECS or EES providing the NM service. The NMC 301 may receive a request message for generating a notification channel from the EEC 303, and may transmit a notification channel request to the NMS based on information included in the request message received from the EEC 303. Operation 321 is represented as “Request to receive notifications” in FIG. 3.

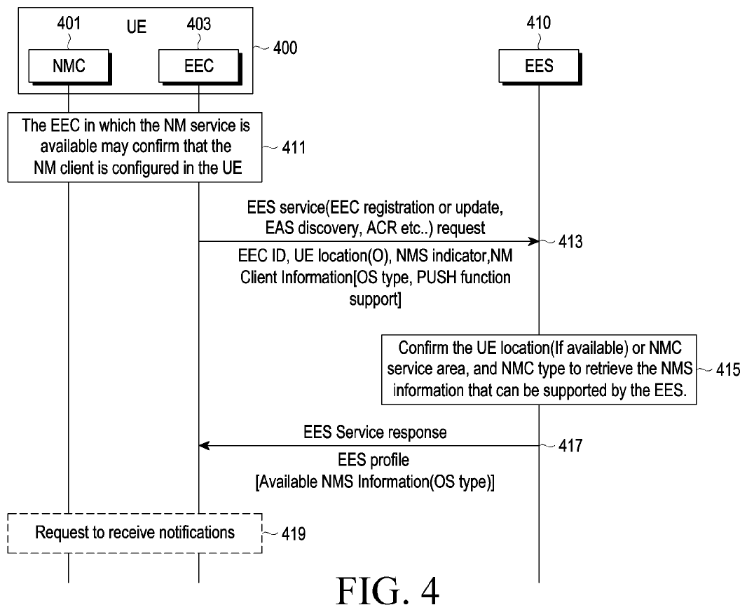

FIG. 4 is a view schematically illustrating a procedure for creating a notification channel related to a notification management service in a wireless communication system according to an embodiment of the disclosure.

The procedure for creating a notification channel related to the notification management service in the wireless communication system illustrated in FIG. 4 may include a procedure of configuring the notification management server information available to the EES 410 based on the NMC information about the UE 400 to generate a notification channel related to the notification management service in the wireless communication system and transmitting the configured notification management server information to the UE 400.

Referring to FIG. 4, the UE 400 may include an NMC 401 and an EEC 403. In an embodiment, the EEC 403 may provide the EES 410 with the NMC information configured in the UE 400. In an embodiment, the EEC 403 may include NMC information configured in the UE 400 in an EEC registration request message, or an EEC registration update request message, an EAS discovery message, or an application context relocation (ACR) request message, and transmit the EEC registration request message, the EEC registration update request message, the EAS discovery message, or the ACR request message including the NMC information configured in the UE 400, to the EES 410, thereby providing the NMC information configured in the UE 400 to the EES 410. The EES 410 may identify the NMS information supportable for the UE 400 based on the NMC information included in the EEC service request message (e.g., an EEC registration request message, an EEC registration update request message, or an EAS discovery message, or an ACR request message) of the EEC 403, and may provide the identified NMS information supportable for the UE 400 to the EEC 403. In an embodiment, the EES 410 may provide the NMS information supportable for the UE 400 to the EEC 403 by including the NMS information supportable for the UE 400 in the service response message and transmitting the service response message to the EEC 403.

In an embodiment, the EEC 403 may identify the notification management service available in the EEC 403 based on the notification management client information (e.g., OS type, PUSH function support) previously configured in the UE 400.

As described above, the procedure for configuring the notification management server information available to the EES 410 based on the NMC information about the UE 400 and transmitting the configured notification management server information to the UE 400 may be described in detail as follows.

In operation 411, the notification management service (NM service) may be useful in the EEC 403, and the EEC 403 where the notification management service is useful may identify that the NM client (NMC) 401 is configured in the UE 400. Operation 411 is represented in FIG. 4 as “The EEC in which the NM service is available may confirm that the NM client is configured in the UE”. In operation 413, the EEC 403 may provide at least one of the EEC ID, NMC information (e.g., OS type, PUSH function support) configured in the UE 400, location information about the UE 400, and an NMS indicator indicating that the EEC 403 provides the notification management service to the EES 410 through an EEC registration request message (e.g., the EEC registration request message, the EEC registration update request message, the EAS discovery message, or the ACR request message).

In operation 415, the EES 410 may receive the EES service request message from the EEC 403 and, when an NMS indicator is included in the EES service request message, the EES 410 may search for available NMS information. The EES 410 may consider the NMC information (e.g., OS type, PUSH function support) included in the received EES service request message, service area information supported by the NMS and location information about the UE 400 or prediction path information for the UE 400 in order to search for available NMS information. The location information about the UE 400 may be the EES service request message received from the EEC 403, or, if necessary, location information about the UE 400 obtained by the EES 410 using the 5GC core network function. In operation 415, it is represented in FIG. 4 as “Confirm the UE location (If available) or NMC service area, and NMC type to retrieve the NMS information that can be supported by the EES”.

In operation 417, the EES 410 may include and provide the configured or matched NMS information (e.g., NMS information available in the UE 400) in the EES service response message to the EES service request message of the EEC 403 (EEC registration request message, EEC registration update request message, EAS discovery message, or ACR request message).

In operation 417, the EEC 403 may receive the NMS information supported by the EES 410 through the EES service response message to the EES service request message (e.g., the EEC registration request message, EEC registration update request message, EAS discovery message, or ACR request message) received from the EES 410.

In operation 419, the EEC 403 may identify the NMS information included in the received EES service response message and transfer a request message (e.g., a notification reception request message) for generating a notification channel based on the identified NMS information to the NMC 401 in order to receive a server notification through the notification channel from the EES 410 providing the NM service. The NMC 401 may receive a request message for generating a notification channel from the EEC 303, and may transmit a notification channel request to the NMS based on information included in the request message received from the EEC 403. Operation 419 is represented as “Request to receive notifications” in FIG. 4.

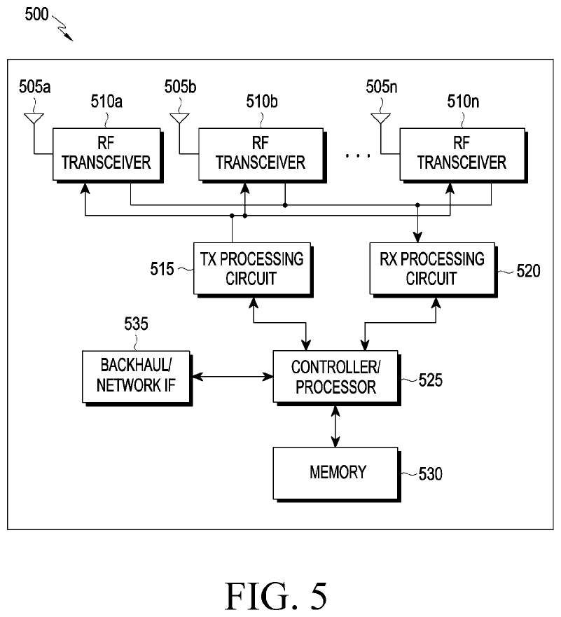

FIG. 5 is a view illustrating an internal structure of a network entity in a wireless communication system according to an embodiment.

The internal structure of the network entity 500 illustrated in FIG. 5 is merely an example, and the internal structure of the network entity 500 may not be limited to the implementation illustrated in FIG. 5.

Referring to FIG. 5, the network entity 500 includes a plurality of antennas 505a to 505n, a plurality of radio frequency (RF) transceivers 510a to 510n, a transmit (TX) processing circuit 515, and a receive (RX) processing circuit 520. The network entity 500 further includes a controller/processor 525, memory 530, and a backhaul or network interface 535. The RF transceivers 510a to 510n receive input RF signals, such as signals transmitted from UEs in the wireless communication network, through the antennas 505a to 505n. The RF transceivers 510a to 510n down-convert the input RF signals, generating intermediate frequency (IF) or baseband signals. The IF or baseband signals are transmitted to the RX processing circuit 520, and the RX processing circuit 520 filters, decodes, and/or digitizes the baseband or IF signals, generating processed baseband signals. The RX processing circuit 520 sends the processed baseband signals to the controller/processor 525 for further processing.

The TX processing circuit 515 receives analog or digital data, such as speech data, web data, emails, or interactive video game data, from the controller/processor 525. The TX processing circuit 515 encodes, multiplexes, and/or digitizes the output baseband data, generating processed baseband or IF signals. The RF transceivers 510a to 510n receive the processed baseband or IF signals output from the TX processing circuit 515 and up-convert the baseband or IF signals into RF signals which are to be transmitted through the antennas 505a to 505n.

The controller/processor 525 may include one or more processors or other processing devices that control the overall operation of the network entity 500. In an embodiment, the network entity 500 may be any one of various network entities, such as ECS or EES. The overall operation of the network entity 500 may be implemented to be similar or substantially identical to that described in FIGS. 1 to 4. Therefore, a detailed description thereof is omitted here.

In one example, the controller/processor 525 may control reception of forward channel signals and transmission of reverse channel signals by the RF transceivers 510a to 510n, the processing circuit 520, and the TX processing circuit 515 according to known principles. The controller/processor 525 may support additional functions, such as more advanced wireless communication functions. For example, any one of other various functions may be supported by the controller/processor 525 in the network entity 500. In an embodiment, the controller/processor 525 includes at least one microprocessor or microcontroller. The controller/processor 525 may be implemented as at least one processor, and may be referred to as a “processor.”

The controller/processor 525 may also execute programs and other processes, e.g., operating system (OS), resident in the memory 530. The controller/processor 525 may move data as required by a running process to the memory 530 or the outside of the memory 530. In specific embodiments, the controller/processor 525 supports communication between entities. The controller/processor 525 may move data to the memory 530 or the outside of the memory 530 according to the running process.

The controller/processor 525 is coupled with the backhaul or network interface 535. The backhaul or network interface 535 allows the network entity 500 to communicate with other devices or systems over a backhaul connection or over a network. The interface 535 may support communications over any appropriate wired or wireless connection(s). For example, when the network entity 500 is implemented as a part of a cellular communication system supporting 5th generation (5G)/new radio (NR), long term evolution (LTE), or long term evolution-advanced (LTE-A), the interface 535 may allow the network entity 500 to communicate with other network entities through wired or wireless backhaul connections. When the network entity 500 is implemented as an access point, the network interface 535 allows the network entity 500 to communicate with a larger network (e.g., the Internet) via a wired or wireless local area network or a wired or wireless connection. The interface 535 includes an appropriate structure to support communications through a wired or wireless connection, such as Ethernet or RF transceiver.

Although FIG. 5 illustrates an example of the network entity 500, various changes may be made thereto. As an example, the network entity 500 may include any number of such components as illustrated in FIG. 5. As a specific example, an access point may include a plurality of interfaces 535, and the controller/processor 525 may support routing functions to route data between different network addresses. As another specific example, although it is illustrated that a single instance of the TX processing circuit 515 and a single instance of the RX processing circuit 520 are included, the network entity 500 may include a plurality of instances of each (like one for each RF transceiver). Various components of FIG. 5 may be combined together, or each component may be further divided or some components may be omitted or, as necessary, more components may be added.

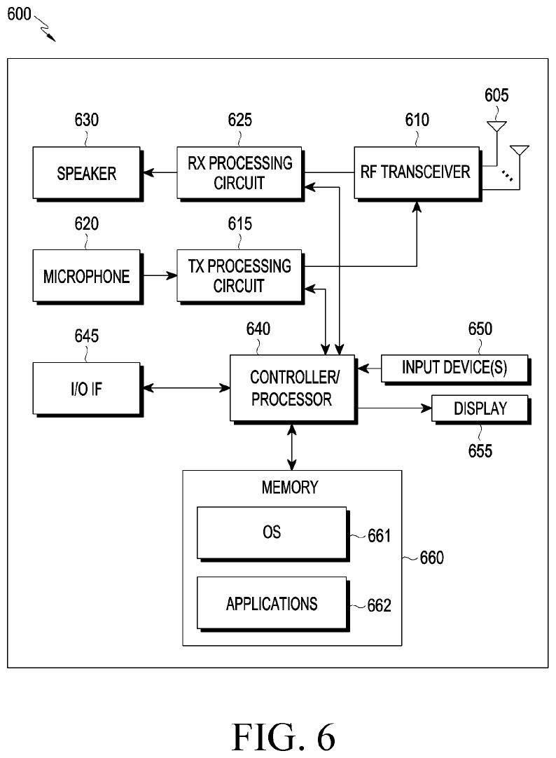

FIG. 6 is a view illustrating an internal structure of a UE in a wireless communication system according to an embodiment.

The internal structure of the UE 600 illustrated in FIG. 6 is merely an example, and the internal structure of UE 600 may not be limited to the implementation illustrated in FIG. 6.

As illustrated in FIG. 6, the UE 600 may include an antenna 605, a radio frequency (RF) transceiver 610, a transmit (TX) processing circuit 615, a microphone 620, and an RX processing circuit 625. The UE 600 also includes a speaker 630, a controller/processor 640, an input/output (I/O) interface (IF) 645, an input device 650, a display 655, and memory 660. The memory 660 includes an operating system (OS) 661 and one or more applications 662.

The RF transceiver 610 receives an incoming RF signal transmitted by a network entity of a wireless communications network from the antenna 605. The RF transceiver 610 down-converts the input RF signal, generating an intermediate frequency (IF) or baseband signal. The IF or baseband signal is transmitted to the RX processing circuit 625, and the RX processing circuit 625 filters, decodes, and/or digitizes the baseband or IF signal, generating a processed baseband signal. The RX processing circuit 625 sends the processed baseband signal to the speaker 630 (e.g., as for audio data) or the processor 640 (e.g., as for web browsing data) for further processing.

The TX processing circuit 615 receives analog or digital speech data from the microphone 620 or other output baseband data (e.g., web data, emails, or interactive video game data) from the processor 640. The TX processing circuit 615 encodes, multiplexes, and/or digitizes the output baseband data, generating a processed baseband or IF signal. The RF transceiver 610 receives the processed baseband or IF signal output from the TX processing circuit 615 and up-converts the baseband or IF signal into an RF signal which is to be transmitted through the antenna 605.

The controller/processor 640 may include one or more processors or other processing devices, and may execute the OS 661 stored in the memory 660 to control the overall operation of the UE 600. In an embodiment, the overall operation of the UE 600 may be implemented to be similar or substantially identical to that described in FIGS. 1 to 4. Therefore, a detailed description thereof is omitted here. For example, the controller/processor 640 may control the reception of forward channel signals and transmission of reverse channel signals by the RF transceiver 610, the RX processing circuitry 625, and the TX processing circuitry 615 according to known principles. According to some embodiments, the controller/processor 640 includes at least one microprocessor or microcontroller.

The controller/processor 640 may also execute other processes and programs residing in the memory 660, such as processes for beam management. The controller/processor 640 may move data into or out of the memory 660 as required by a running process. According to an embodiment, the processor 640 is configured to execute the applications 662 based on the OS program 661 or in response to signals received from network entities or the operator. The controller/processor 640 is coupled to the I/O interface 645, and the I/O interface 645 provides the UE 600 with connectibility to other devices, e.g., laptop computers and handheld computers. The I/O interface 645 is a communication path between these accessories and the processor 640. The controller/processor 640 is also coupled to the input device 650 and the display unit 655. The operator of the UE 600 may enter data into the UE 600 using the input device 650. The input device 650 may be a keyboard, touchscreen, mouse, trackball, voice input, or other device capable of operating as the user interface to allow the user to interact with the UE 600. In another example, the input device 650 may include a touch panel, a (digital) pen sensor, keys or an ultrasonic input device. The touch panel may recognize touch inputs in at least one of capacitive, resistive, infrared, or ultrasonic methods.

The controller/processor 640 is also coupled to the display 655. The display 655 may be a liquid crystal display, a light emitting diode display, or other displays capable of rendering text and/or at least limited graphics, such as from websites.

The memory 660 is coupled to the processor 640. A portion of the memory 660 may include a random access memory (RAM), and the remainder of the memory 660 may include a flash memory or a read-only memory (ROM).

Although FIG. 6 illustrates an example of the UE 600, various changes may be made thereto. For example, various components of FIG. 6 may be combined together, each component may be further divided, or some components may be omitted, or other components may be added as necessary. As an example, the controller/processor 640 may be divided into multiple processors, such as one or more central processing units (CPUs) and one or more graphics processing units (GPUs). The controller/processor 640 may be implemented as at least one processor, and may be referred to as a “processor.” Although the UE 600 is configured as a mobile phone or a smart phone in FIG. 6, the UEs may be configured to operate as a different type of mobile or stationary device.

According to an embodiment of the disclosure, there is provided an operation method of an EEC. The operation method comprises transmitting, to an edge enabler server (EES), notification management client (NMC) information supported by a UE, including preferred channel information about the UE for a notification subscription service, identifying the NMC information received from the EEC and searching for a notification management server (NMS) supporting a UE preferred channel available in the EES, selecting an NMS suitable for an area capable of providing a notification subscription service to the UE, transmitting information about an NMS accessible by the EES to the EEC, transmitting, to the ECS by the EEC, NMC information supported by the UE, including preferred channel information about the UE for a notification subscription service, identifying the NMC information received from the EEC, and searching for an NMS supporting a UE preferred channel available in the ECS, selecting an NMS suitable for an area capable of providing a notification subscription service to the UE, transmitting, to the EEC, information about an NMS accessible by the ECS, including and transmitting the information about the NMS accessible by the ECS in a registration request message, to the ECS, and including the NMS information received from the EES by the ECS in a response message to the registration request message and transmit NMS information supportable by the EES or the ECS to the UE.

According to an embodiment of the disclosure, there is provided a method of an edge configuration server (ECS) in a wireless communication system.

The method comprises receiving, from an edge enabler server (EES), a first message including available notification management server (NMS) information, receiving, from an edge enabler client (EEC), a second message including notification management client (NMC) information configured in a user equipment (UE), configuring NMS information available in the UE based on the NMS information and the NMC information, and transmitting, to the EEC, a third message including the configured NMS information.

According to an embodiment of the disclosure, configuring the NMS information available in the UE based on the NMS information and the NMC information includes, when the second message may include an indicator indicating that the EEC provides a notification management service, retrieving the NMC information or NMS information available to the NMC or the ECS or EES, configured in the ECS, and configuring the NMS information available in the UE based on the NMC information and the NMS information available to the ECS or the EES.

According to an embodiment of the disclosure, when the second message includes location information about the UE, retrieving the NMS information available to the ECS or the EES includes retrieving the NMS information available to the ECS or the EES based on service area information supported by the NMS and the location information about the UE.

According to an embodiment of the disclosure, the second message further includes at least one of an identifier of the EEC, location information about the UE, and an indicator indicating that the EEC provides a notification management service.

According to an embodiment of the disclosure, the NMC information includes at least one of an operating system (OS) type and push function support information.

According to an embodiment of the disclosure, the available NMS information includes an operating system (OS) type.

According to an embodiment of the disclosure, the third message includes edge data network (EDN) configuration information, and the configured NMS information is included in the EDN configuration information.

According to an embodiment of the disclosure, the second message is received when a notification management service is available in the UE.

According to an embodiment of the disclosure, the first message includes an edge enabler server (EES) registration request message or an EES registration update request message.

According to an embodiment of the disclosure, the second message includes a service provisioning request message or a service provisioning subscription request message.

According to an embodiment of the disclosure, there is provided an edge configuration server (ECS) in a wireless communication system. The ECS comprises a transceiver, and at least one processor coupled to the transceiver. The at least one processor is configured to receive, from an edge enabler server (EES) through the transceiver, a first message including available notification management server (NMS) information, receive, from an edge enabler client (EEC) through the transceiver, a second message including notification management client (NMC) information configured in a user equipment (UE), configure NMS information available in the UE based on the NMS information and the NMC information, and transmit, to the EEC through the transceiver, a third message including the configured NMS information.

According to an embodiment of the disclosure, the at least one processor is configured to when the second message includes an indicator indicating that the EEC provides a notification management service, retrieve the NMC information or NMS information available to the NMC or the ECS or EES, configured in the ECS, and configure the NMS information available in the UE based on the NMC information and the NMS information available to the ECS or the EES.

According to an embodiment of the disclosure, the at least one processor is configured to when the second message includes location information about the UE, retrieve the NMS information available to the ECS or the EES based on service area information supported by the NMS and the location information about the UE.

According to an embodiment of the disclosure, the second message may further include at least one of an identifier of the EEC, location information about the UE, and an indicator indicating that the EEC provides a notification management service.

According to an embodiment of the disclosure, the NMC information may include at least one of an operating system (OS) type and push function support information.

According to an embodiment of the disclosure, the available NMS information includes an operating system (OS) type.

According to an embodiment of the disclosure, the third message includes edge data network (EDN) configuration information, and the configured NMS information is included in the EDN configuration information.

According to an embodiment of the disclosure, the second message is received when a notification management service is available in the UE.

According to an embodiment of the disclosure, the first message includes an edge enabler server (EES) registration request message or an EES registration update request message.

According to an embodiment of the disclosure, the second message includes a service provisioning request message or a service provisioning subscription request message.

The methods according to the embodiments descried in the specification or claims of the disclosure may be implemented in hardware, software, or a combination of hardware and software.

When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described in the specification or claims of the disclosure.

The programs (software modules or software) may be stored in random access memories, non-volatile memories including flash memories, read-only memories (ROMs), electrically erasable programmable read-only memories (EEPROMs), magnetic disc storage devices, compact-disc ROMs, digital versatile discs (DVDs), or other types of optical storage devices, or magnetic cassettes. Or, the programs may be stored in memory constituted of a combination of all or some thereof. As each constituting memory, multiple ones may be included.

The programs may be stored in attachable storage devices that may be accessed via a communication network, such as the Internet, Intranet, local area network (LAN), wide area network (WAN), or storage area network (SAN) or a communication network configured of a combination thereof. The storage device may connect to the device that performs embodiments of the disclosure via an external port. A separate storage device over the communication network may be connected to the device that performs embodiments of the disclosure.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

Although specific embodiments of the present invention have been described above, various changes may be made thereto without departing from the scope of the present invention. Thus, the scope of the disclosure should not be limited to the above-described embodiments, and should rather be defined by the following claims and equivalents thereof.

1. A method of an edge configuration server (ECS) in a wireless communication system, the method comprising:
receiving, from an edge enabler server (EES), a first message including available notification management server (NMS) information;
receiving, from an edge enabler client (EEC), a second message including notification management client (NMC) information configured in a user equipment (UE);
configuring NMS information available in the UE based on the NMS information and the NMC information; and
transmitting, to the EEC, a third message including the configured NMS information.

2. The method of claim 1, wherein configuring the NMS information available in the UE based on the NMS information and the NMC information comprises:
in case that the second message includes an indicator indicating that the EEC provides a notification management service, retrieving the NMC information or NMS information available to the NMC or the ECS or EES, configured in the ECS; and
configuring the NMS information available in the UE based on the NMC information and the NMS information available to the ECS or the EES.

3. The method of claim 2, wherein in case that the second message includes location information of the UE, retrieving the NMS information available to the ECS or the EES comprises retrieving the NMS information available to the ECS or the EES based on service area information supported by the NMS and the location information of the UE.

4. The method of claim 1, wherein the second message further includes at least one of an identifier of the EEC, location information of the UE, and an indicator indicating that the EEC provides a notification management service.

5. The method of claim 4, wherein the NMC information includes at least one of an operating system (OS) type and PUSH function support information.

6. The method of claim 1, wherein the available NMS information includes an operating system (OS) type.

7. The method of claim 1, wherein the third message includes edge data network (EDN) configuration information, and the configured NMS information is included in the EDN configuration information.

8. The method of claim 1, wherein the second message is received in case that a notification management service is available in the UE.

9. The method of claim 1, wherein the first message includes an edge enabler server (EES) registration request message or an EES registration update request message.

10. The method of claim 1, wherein the second message includes a service provisioning request message or a service provisioning subscription request message.

11. An edge configuration server (ECS) in a wireless communication system, comprising:
a transceiver; and
at least one processor coupled to the transceiver, wherein the at least one processor is configured to:
receive, from an edge enabler server (EES) through the transceiver, a first message including available notification management server (NMS) information;
receive, from an edge enabler client (EEC) through the transceiver, a second message including notification management client (NMC) information configured in a user equipment (UE);
configure NMS information available in the UE based on the NMS information and the NMC information; and
transmit, to the EEC through the transceiver, a third message including the configured NMS information.

12. The ECS of claim 11, wherein the at least one processor is configured to:
in case that the second message includes an indicator indicating that the EEC provides a notification management service, retrieve the NMC information or NMS information available to the NMC or the ECS or EES, configured in the ECS; and
configure the NMS information available in the UE based on the NMC information and the NMS information available to the ECS or the EES.

13. The ECS of claim 12, wherein the at least one processor is configured to, in case that the second message includes location information of the UE, retrieve the NMS information available to the ECS or the EES based on service area information supported by the NMS and the location information of the UE.

14. The ECS of claim 11, wherein the second message further includes at least one of an identifier of the EEC, location information of the UE, and an indicator indicating that the EEC provides a notification management service.

15. The ECS of claim 14, wherein the NMC information includes at least one of an operating system (OS) type and PUSH function support information.
